(19) United States
(12) Patent Application Publication
(10) Pub. No.: US 2026/0163389 A1
(43) Pub. Date: Jun. 11, 2026

(54) CARE APPARATUS AND CHARGING ASSEMBLY

(71) Applicant: Shenzhen Soocas Technology Co., Ltd., Shenzhen (CN)

(72) Inventors: Mingyu WANG, Shenzhen (CN); Zhikun YIN, Shenzhen (CN)

(73) Assignee: Shenzhen Soocas Technology Co., Ltd., Shenzhen (CN)

(21) Appl. No.: 19/428,411

(22) Filed: Dec. 22, 2025

Related U.S. Application Data
(63) Continuation of application No. PCT/CN2025/114242, filed on Aug. 13, 2025.

(30) Foreign Application Priority Data
Dec. 6, 2024 (CN) 2024118030293

(51) Int. Cl. H02J 7/60; H02J 7/42; H02J 7/70; H02J 7/80

(52) U.S. Cl. CPC H02J 7/663; H02J 7/42; H02J 7/685; H02J 7/70; H02J 7/80; H02J 2207/30

(57) ABSTRACT

Embodiments of the disclosure disclose a care apparatus and a charging assembly. By connecting a switch module in series in a power supply circuit of the charging assembly, the power supply circuit for charging a care apparatus body is controlled to be on and off through the switch module. In a case that a first control module of the care apparatus body determines that a conductive foreign object exists in an electrical interface, a feedback signal is sent to a second control module. The second control module controls the switch module to be off after receiving the feedback signal, so that the power supply circuit becomes an open circuit, thereby switching off the power supply circuit for charging the care apparatus body. A power supply of the care apparatus body is switched off from the charging assembly to form power-off protection.

### CROSS-REFERENCE TO RELATED APPLICATIONS

The application is a continuation of International Application No. PCT/CN2025/114242, filed on August 13, 2025, which claims the priority to Chinese Patent Application No. 2024118030293 filed on December 6, 2024 and entitled "Care Apparatus and Charging Assembly", the entire contents of which are incorporated herein by reference.

### TECHNICAL FIELD

The present application relates to the technical field of care appliances, and particularly to a care apparatus and a charging assembly.

### BACKGROUND

Electric toothbrushes, razors and other care apparatuses are inevitably in contact with water during use, and improper use by users may lead to water immersion into an electrical interface. Moreover, electric toothbrushes, razors and other care apparatuses are usually placed in a bathroom, and a bathroom environment is high in humidity, which may also cause immersion of humid air into the electrical interface. Therefore, there may be a short circuit inside the electrical interface when the apparatus is charged. If the apparatus is continuously charged, hot melting of the electrical interface may occur, and there is even a fire risk.

No safe solution has been proposed at present for the above problem.

### SUMMARY

Embodiments of the present application provide a care apparatus and a charging assembly.

In order to solve the above technical problem, the embodiments of the present application are implemented as follows.

A care apparatus is provided, wherein the care apparatus includes: a care apparatus body and a charging assembly;

the care apparatus body includes: an electrical interface and a first control module; and the electrical interface is configured as an electrical connector for charging the care apparatus body;

the charging assembly includes: a second control module and a switch module; and the switch module is connected in series with a power supply circuit in the charging assembly;

the second control module is in communication connection with the first control module; and

the first control module is configured to send a feedback signal to the second control module in a case that a conductive foreign object exists in the electrical interface; and the second control module is configured to control the switch module to be off after receiving the feedback signal.

A charging assembly is provided, wherein the charging assembly includes a switch module and a second control module;

the switch module is connected in series with a power supply circuit of the charging assembly; and

the second control module is configured to control the switch module to be off in a case of receiving a feedback signal from the first control module; the first control module is a module in communication connection with the second control module; the first control module is configured to send the feedback signal to the second control module in a case that a conductive foreign object exists in an electrical interface of an apparatus charged by the charging assembly; and the electrical interface is configured as an electrical connector of the apparatus.

### BRIEF DESCRIPTION OF THE DRAWINGS

In order to illustrate the technical solutions in the embodiments of the present application more clearly, the drawings used in the description of the embodiments will be briefly described below. Obviously, the drawings in the following description are merely some embodiments of the present application. Those of ordinary skills in the art can also obtain other drawings based on these drawings without going through any creative effort.

FIG. 1 is a schematic structural diagram of a care apparatus provided by the embodiment of the present application;

FIG. 2 is a schematic diagram of an electrical interface provided by the embodiment of the present application;

FIG. 3 is a schematic diagram of an electrical joint provided by the embodiment of the present application;

FIG. 4 is a schematic diagram of an overall structure of a detection protection system provided by the embodiment of the present application; and

FIG. 5 is a schematic diagram of an electrical structure of the detection protection system provided by the embodiment of the present application.

### Reference Numerals:

1 - care apparatus body, 11 - first control module, 12 - electrical interface, 13 - detection module, and 14 - second protection circuit; and

2 - charging assembly, 21 - adapter, 22 - transmission cable, 221 - second control module, and 222 - switch module.

### DETAILED DESCRIPTION OF THE EMBODIMENTS

In order to make the objectives, technical solutions and advantages of one or more embodiments of the present application clearer, the technical solutions in one or more embodiments of the present application are clearly and completely described hereinafter with reference to specific embodiments of the present application and corresponding drawings. Obviously, the embodiments described are only a part of, rather than all of, the embodiments of the present application. Based on the embodiments in the present application, all other embodiments obtained by those of ordinary skills in the art without going through any creative effort should fall within the scope of protection of one or more embodiments of the present application.

The technical solution provided by each embodiment of the present application will be described in detail hereinafter with reference to the drawings.

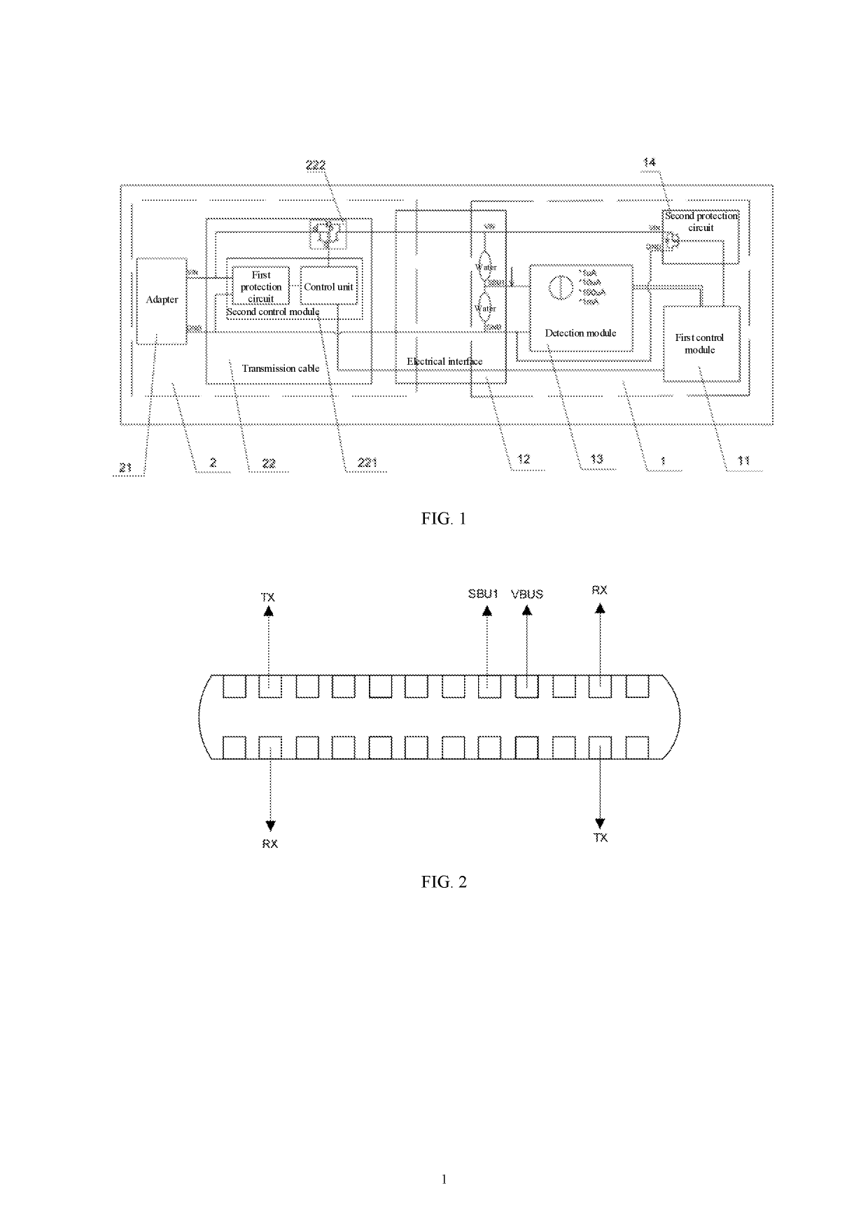

FIG. 1 is a schematic structural diagram of a care apparatus provided by the embodiment of the present application. As shown in FIG. 1, the care apparatus provided by the present application may include a care apparatus body 1 and a charging assembly 2.

The care apparatus body 1 may include: an electrical interface 12 and a first control module 11; and the electrical interface 12 may be configured as an electrical connector for charging the care apparatus body.

The charging assembly 2 may include: a second control module 221 and a switch module 222; and the switch module 222 is connected in series with a power supply circuit in the charging assembly 2.

The second control module 221 is in communication connection with the first control module 11.

The first control module 11 may be configured to send a feedback signal to the second control module 221 in a case that a conductive foreign object exists in the electrical interface 12; and the second control module 221 is configured to control the switch module 222 to be off after receiving the feedback signal.

In the embodiment of the present application, the care apparatus body 1 may be an electric razor, an electric hair clipper, an electric face cleaner, an electric tooth cleaner and other apparatuses; and the charging assembly 2 may be a device for charging the care apparatus body 1 above.

The first control module 11 and the second control module 221 may be control modules including at least one of a circuit board and an MCU; and types and models of the first control module 11 and the second control module 221 may be the same or different, which will not be specifically limited herein.

In practical application, the first control module 11 and the second control module 221 may communicate in a wireless mode. Specifically, the first control module 11 and the second control module 221 with a wireless communication function may be selected to achieve the wireless communication function; and the first control module 11 and the second control module 221 may also be respectively provided with a wireless communication unit to achieve the wireless communication function.

The first control module 11 and the second control module 221 may also communicate in a wired mode.

In the embodiment of the present application, the electrical interface 12 may be an interface arranged on the care apparatus body 1 for supplying electric energy to the care apparatus body. Specifically, the electrical interface 12 may be used for charging an energy storage element configured in the care apparatus body 1; and may also be used for directly supplying electric energy to the care apparatus body 1. In the embodiment of the present application, the operation of charging the care apparatus body may refer to charging the energy storage element configured in the care apparatus body 1; and may also refer to directly supplying electric energy to the care apparatus body 1. The electrical interface 12 may be a Type-C interface, a lighting interface, a trapezoidal Micro USB interface, and the like. The conductive foreign object may be a conductive liquid, a conductive solid, and the like.

Specifically, the power supply circuit may be arranged in the charging assembly 2. It can be understood that, after the charging assembly 2 is connected with the power supply, if the power supply circuit is switched on, the care apparatus body 1 may be charged; and if the power supply circuit is switched off, the charging of the care apparatus body 1 may be stopped. During charging, in the case that the conductive foreign object exists in the electrical interface 12, there may be a short circuit of the power supply circuit in the electrical interface 12, which may lead to a damage of the electrical interface 12 or a damage of the care apparatus body 1, and may even lead to a fire in severe cases. Therefore, in the case that it is detected that the conductive foreign object exists in the electrical interface 12 during charging, certain protective measures need to be taken.

In the embodiment of the present application, the switch module 222 is connected in series in the power supply circuit of the charging assembly 2, and whether the power supply circuit is switched on or not may be controlled by the switch module 222. Specifically, when the second control module 221 receives the feedback signal reflecting that the conductive foreign object exists in the electrical interface 12 sent by the first control module 11, the switch module 222 may be controlled to be off, so that the power supply circuit forms an open circuit, that is, a power supply for charging the care apparatus body is switched off. The power supply for charging the care apparatus body 1 is switched off from the charging assembly 2 to form power-off protection, which avoids a short circuit of the power supply circuit in the electrical interface 12, thereby improving a charging safety of the care apparatus.

In practical application, because wireless communication is easily interfered by electromagnetic waves and other external factors, signal transmission speed and stability may be affected, leading to poor communication reliability; and in order to ensure that the second control module 221 can receive the feedback signal sent by the first control module 11, so as to ensure the charging safety of the case apparatus, wired communication may be preferably used in the embodiment of the present application.

Specifically, at least one pin of the electrical interface 12 is configured as a first communication pin; and the first control module 11 is connected with the first communication pin.

The charging assembly 2 further includes a transmission cable 22 with an electrical joint; at least one pin of the electrical joint is configured as a second communication pin; and the second control module 221 is connected with the second communication pin.

The electrical interface 12 is coupled with the electrical joint, the first communication pin is connected with the second communication pin to form an electrical loop, and the second control module 221 is in communication connection with the first control module 11.

FIG. 2 is a schematic diagram of the electrical interface provided by the embodiment of the present application. As shown in FIG. 2, a plurality of pins may be arranged in the electrical interface 12.

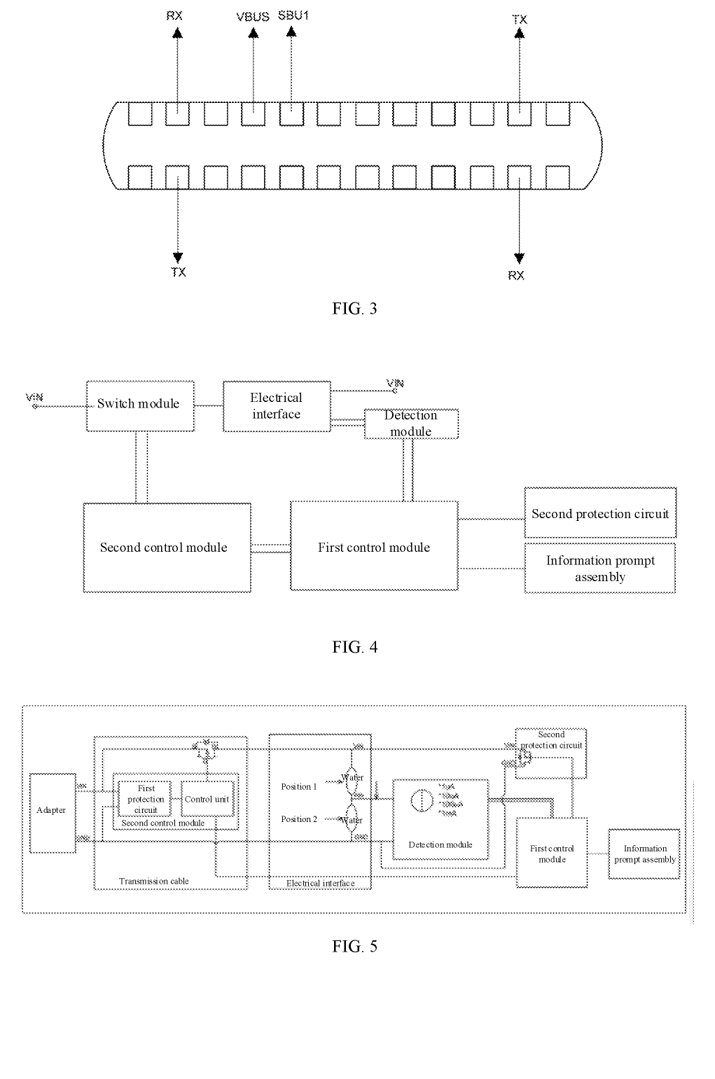

FIG. 3 is a schematic diagram of the electrical joint provided by the embodiment of the present application. As shown in FIG. 3, a plurality of pins may also be arranged in the electrical joint.

When the electrical interface 12 is coupled with the electrical joint, the plurality of pins in the electrical interface 12 may be correspondingly connected with the plurality of pins in the electrical joint, so as to transmit energy or signals.

In the embodiment of the present application, when the electrical interface 12 is coupled with the electrical joint, the first communication pin may be connected with the second communication pin to form a complete communication link, so that the first control module 11 may communicate with the second control module 221. The first communication pin may be connected with a data sending pin or a signal output pin of the first control module 11, which may be specifically selected according to an actual situation, and will not be specifically limited herein. The second communication pin may be connected with a data receiving pin or a signal input pin of the second control module 221, which may be specifically selected according to an actual situation, and will not be specifically limited herein.

In practical application, a TX pin in the electrical interface 12 may be used as the first communication pin, and correspondingly, a TX pin in a corresponding position of the electrical joint may be used as the second communication pin; and certainly, an RX pin in the electrical interface 12 may also be used as the first communication pin, and correspondingly, an RX pin in a corresponding position of the electrical joint may be used as the second communication pin.

As one embodiment, two TX pins skew-symmetrically arranged in the electrical interface 12 may be used as the first communication pins, and correspondingly, two TX pins skew-symmetrically arranged in corresponding positions of the electrical joint may be used as the second communication pins. Certainly, two RX pins skew-symmetrically arranged in the electrical interface 12 may also be used as the first communication pins, and correspondingly, two RX pins skew-symmetrically arranged in corresponding positions of the electrical joint may be used as the second communication pins. Therefore, the electrical interface 12 and the electrical joint may communicate regardless of forward insertion and reverse insertion.

In the embodiment of the present application, the wired communication between the first control module 11 and the second control module 221 is directly achieved by using the electrical joint and the electrical interface 12, and there is no need to select the control module with the communication function or additionally configure the wireless communication unit, thereby saving resources and costs; and meanwhile, a success rate of the second control module 221 receiving the feedback signal sent by the first control module 11 is improved, thereby improving the charging safety of the care apparatus.

Optionally, the electrical interface 12 may be configured to have two first communication pins, and the two first communication pins may be respectively located on two opposite sides of the electrical interface 12, and/or,

the electrical joint may be configured to have two second communication pins, and the two second communication pins may be respectively located on two opposite sides of the electrical joint.

The electrical interface 12 may include two first communication pins, and the two first communication pins may be diagonally arranged, such as TX or RX in FIG. 2. The two first communication pins may both be connected with the data sending pin of the first control module 11. Certainly, the electrical interface 12 may also include only one first communication pin.

The electrical joint may also include two second communication pins, and the two second communication pins may be diagonally arranged, such as TX or RX in FIG. 3. The two second communication pins may both be connected with the data receiving pin of the second control module 221. Certainly, the electrical joint may also include only one second communication pin.

In the embodiment of the present application, two communication pins are arranged in at least one of the electrical interface 12 and the electrical joint, and the two communication pins are diagonally arranged, so that when the electrical joint is connected to the electrical interface 12, it is unnecessary to identify forward and reverse directions, thereby improving use convenience; and meanwhile, a situation that the first control module 11 and the second control module 221 cannot communicate when the electrical joint is connected to the electrical interface 12 in an incorrect direction is avoided, thereby improving the charging safety of the care apparatus.

In practical application, when a merchant sells the apparatus, the charging assembly 2 provided may only be the transmission cable 22.

Optionally, the charging assembly 2 is the transmission cable 22; and the second control module 221 and the switch module 222 are configured in the transmission cable 22.

The transmission cable 22 may be a data cable with charging and data or signal transmission functions.

Optionally, the transmission cable 22 may include a wire and an electrical joint.

The second control module 221 and the switch module 222 are configured in the wire; or,

the second control module 221 and the switch module 222 are configured in the electrical joint; or,

one of the second control module 221 and the switch module 222 is configured in the electrical joint, and the other of the second control module and the switch module is configured in the wire.

In practical application, the transmission cable 22 may usually include the wire and the electrical joint; and in the embodiment of the present application, the second control module 221 and the switch module 222 may be arranged in the wire of the transmission cable 22. Because the wire usually has a flexible structure, in order to avoid the second control module 221 and the switch module 222 from being damaged when the wire is bent, the wire may also be provided with a protective shell for protecting the second control module 221 and the switch module 222. The second control module 221 and the switch module 222 are arranged in the wire, which can avoid other electrical elements in the transmission cable 22 from affecting the second control module 221. Meanwhile, because the wire is provided with the protective shell, it is convenient for a user to distinguish the transmission cable 22 with a power-off protection function from other data cables.

In addition, the second control module 221 and the switch module 222 may also be arranged in the electrical joint. The second control module 221 and the switch module 222 are arranged in the electrical joint, so that a distance between the second control module 221 and the second communication pin is small, thereby effectively simplifying an internal wiring structure. Moreover, because the electrical joint further includes other circuit structures, the second control module 221 and the switch module 222 are arranged in the electrical joint, which avoids setting mounting positions and structures for the second control module 221 and the switch module 222 separately, thereby simplifying a structure of the transmission cable 22.

In practical application, according to actual demands, one of the second control module 221 and the switch module 222 may also be arranged in the electrical joint, and the other of the second control module and the switch module is arranged in the wire. For example, the second control module 221 may be arranged in the electrical joint, and the switch module 222 is arranged in the wire. Alternatively, the second control module 221 may also be arranged in the wire, and the switch module 222 is arranged in the electrical joint.

Optionally, the charging assembly 2 may also be an adapter 21; and the second control module 221 and the switch module 222 may be configured in the adapter 21.

Because a circuit board in the adapter 21 is relatively large, the arrangement of the second control module 221 and the switch module 222 in the adapter 21 can facilitate layout of the second control module 221 and the switch module 222. It can be understood that, in order to ensure the wired communication between the second control module 221 in the adapter 21 and the first control module 11, it is necessary to adopt a data transmission cable provided with a communication cable and the first communication pin.

In practical application, when the energy storage element in the care apparatus body 1 is charged by the charging assembly 2, if a charging voltage is not matched with a standard charging voltage specified for the energy storage element; or a charging current is not matched with a standard charging current specified for the energy storage element, the energy storage element can also be charged, but the service life of the energy storage element may be affected.

On this basis, optionally, the charging assembly 2 may be the transmission cable 22 and the adapter 21.

The second control module 221 and the switch module 222 are configured in the transmission cable 22; or,

the second control module 221 and the switch module 222 are configured in the adapter 21; or,

one of the second control module 221 and the switch module 222 is configured in the adapter 21, and the other of the second control module and the switch module is configured in the transmission cable 22.

In the embodiment of the present application, the energy storage element is charged by the adapter 21 and the transmission cable 22 matched with the care apparatus, so that it is ensured that the charging voltage is matched with the standard charging voltage of the energy storage element; and meanwhile, it may also be ensured that the charging current is matched with the standard charging current of the energy storage element, thereby prolonging the service life of the energy storage element.

In practical application, if the charging assembly 2 includes the transmission cable 22 and the adapter 21, positions of the second control module 221 and the switch module 222 may be set according to actual demands.

If the second control module 221 and the switch module 222 are configured in the transmission cable 22, whether the second control module 221 and the switch module 222 are located in the wire or the charging joint may be determined according to actual needs.

Optionally, the second control module 221 may include a control unit and a first protection circuit.

The control unit may be an MCU; and the control unit may be connected with the switch module and connected with the first control module. The control unit may control the switch module 222 to be on and off according to the feedback signal sent by the first control module.

The first protection circuit may be used for protecting the control unit from being damaged under conditions of overvoltage, overcurrent, surge and electromagnetic interference. A specific structure of the first protection circuit is not specifically limited herein.

The protection of the control unit by the first protection circuit can effectively ensure that the control unit can work normally, which avoids the control unit from being damaged. For example, it can be ensured that the control unit can receive the feedback signal sent by the first control module 11 and output a corresponding control signal, thereby further ensuring the charging safety of the care apparatus.

In order to facilitate controlling the switch module 222 to be on and off, in the embodiment of the present application, the switch module 222 with a control end may be preferably selected.

Optionally, the switch module 222 may be provided with an input end, an output end and a control end; the input end may be connected with one end of a power input cable in the power supply circuit; the output end may be connected with the other end of the power input cable; and the control end may be connected with an output pin of the second control module 221.

In the embodiment of the present application, the switch module 222 may be an electronic switch with an input end, an output end and a control end. The input end and the output end of the switch module 222 may be connected in series in the power input cable of the power supply circuit to control the power input cable to be switched on and off. Whether the input end and the output end of the switch module 222 are switched on or not may be controlled by the control end, thereby controlling the power input cable to be on and off. It can be understood that, when the input end and the output end of the switch module 222 are switched on, the power input cable is switched on, and the power supply circuit is a closed circuit, so that the care apparatus body 1 may be charged; and when the input end and the output end of the switch module 222 are switched off, the power input cable is switched off, and the power supply circuit is an open circuit, which is equivalent to switching off the power supply for charging the care apparatus body 1, so that the charging of the care apparatus body 1 may be stopped.

In practical application, the control end of the switch module 222 may be connected with one output pin of the second control module 221; and after the second control module 221 receives the feedback signal indicating that the conductive foreign object exists in the electrical interface 12 sent by the first control module 11, the second control module 221 may control the output pin connected with the control end to output a low-level signal or a high-level signal, thereby controlling the input end and the output end to be switched off.

In the embodiment of the present application, after the second control module 221 controls the input end and the output end of the switch module 222 to be switched off by the control end, a control signal may also be output after a first time period to control the input end and the output end to be switched on, so as to facilitate availability of the charging assembly 2 used next time. In the case that the first control module 11 determines that the conductive foreign object exists in the electrical interface 12 when the charging assembly is used next time, the second control module 221 may control the input end and the output end of the switch module 222 to be switched off again according to the feedback signal sent by the first control module 11. If a number of receiving times of the feedback signal by the second control module 221 within a preset time period is greater than a preset value, it may be indicated that the user fails to clean the conductive foreign object in the electrical interface 12, and fails to disconnect the electrical interface 12 and the electrical joint; and the signal is output to control the input end and the output end of the switch module 222 to be switched on after a second time period; and the second time period is greater than the first time period.

In the embodiment of the present application, after the second control module 221 receives the feedback signal indicating that the conductive foreign object exists in the electrical interface 12 sent by the first control module 11, the power supply circuit for charging the care apparatus body 1 is switched off by the switch module 222, which avoids a short circuit of the power supply circuit in the electrical interface 12, thereby fundamentally ensuring the charging safety of the care apparatus body 1.

Optionally, the switch module 222 may be a MOS transistor; a source of the MOS transistor may be connected with one end of the power input cable; a drain of the MOS transistor may be connected with the other end of the power input cable; and a gate of the MOS transistor may be connected with the output pin of the second control module 221.

In the embodiment of the present application, the source S of the MOS transistor may be used as the input end, the drain D of the MOS transistor may be used as the output end, and the gate G of the MOS transistor may be used as the control end. The source S and the drain D of the MOS transistor may be connected in series in the power input cable. Whether the MOS transistor is switched on or not may be controlled by controlling the gate G of the MOS transistor.

It can be understood that, when the MOS transistor is a NMOS transistor, the output pin connected with the gate G of the MOS transistor in the second control module 221 may control the MOS transistor to be switched off by outputting the low-level signal; and when the MOS transistor is a PMOS transistor, the output pin connected with the gate G of the MOS transistor in the second control module 221 may control the MOS transistor to be switched off by outputting the high-level signal.

In practical application, the switch module 222 may also be other electronic switches capable of being automatically controlled, such as a bipolar junction transistor, a field effect transistor and a micro relay.

Optionally, the care apparatus may further include a care assembly, the care assembly may include brush filaments, a nozzle, a brush filament carrier and a brush handle, and the brush handle is configured to have a liquid flow channel.

In the embodiment of the present application, the care apparatus may be not only the electric razor, the electric hair clipper, the electric face cleaner and the electric tooth cleaner, but also a compound oral care apparatus with tooth brushing and flushing functions. The care assembly may include the brush filaments for tooth brushing and the nozzle for tooth flushing.

The nozzle may be integrally formed with the brush filament carrier, or additionally assembled on the brush filament carrier, or additionally assembled on the brush handle. The nozzle may be partially or completely surrounded by the brush filaments, or relatively independent from a brush filament area.

In the embodiment of the present application, the liquid flow channel may be a channel arranged inside the brush handle for a tooth flushing fluid to pass through. The tooth flushing fluid may reach the nozzle through the liquid flow channel to be ejected from the nozzle.

In order to achieve tooth brushing and flushing effects, the care apparatus may usually further include a drive assembly.

Optionally, the care apparatus may further include the drive assembly, and the drive assembly may include a pump assembly and/or a motor assembly coupled with the care assembly.

In the embodiment of the present application, the motor assembly may include a motor and a motor shaft. An output end of the motor shaft may be fixedly connected with the care assembly. The motor may drive the brush filaments in the care assembly to vibrate or rotate back and forth through the motor shaft.

The pump assembly may be a power assembly for pumping the tooth flushing fluid to the nozzle. Specifically, the motor shaft may be a hollow shaft; and one end of a hollow part of the motor shaft may be communicated with an output end of the pump assembly, and the other end of the hollow part of the motor shaft may be communicated with the liquid flow channel of the brush handle. The tooth flushing fluid may enter the hollow part of the motor shaft under power of the pump assembly, pass through the liquid flow channel in the brush handle to reach the nozzle, and provide a jet flow to an oral cavity of the user, thereby cleaning the oral cavity.

In practical application, when the compound oral care apparatus with the tooth brushing and flushing functions is used, the tooth brushing and flushing functions may be exerted separately or together. The care apparatus body 1 may also be provided with a button for the user to select an oral cleaning mode.

The embodiment of the present application further provides specific contents about the detection of whether the conductive foreign object exists in the electrical interface 12.

Optionally, the care apparatus body 1 may further include a detection module 13, and the detection module 13 may be in communication connection with the first control module 11; the detection module 13 may be configured to send a first electrical signal to the first control module 11; and the first electrical signal may be used for reflecting a potential at a first pin in the electrical interface 12.

The first control module 11 may be further configured to send the feedback signal to the second control module 221 according to the first electrical signal.

In practical application, the detection module 13 may communicate with the first control module 11 through a serial communication mode. Specifically, the first control module 11 may communicate with the second control module 221 through one or more communication modes of SPI, IIC, RS232 and RS485.

In the embodiment of the present application, the first pin may be any one of pins excluding a power input pin in the electrical interface 12; and specifically, the first pin may be a pin close to the power input pin VBUS, for example, the first pin may be an SBU1 pin, as shown in FIG. 2 or FIG. 3.

Due to a small size of the electrical interface 12, in a use environment such as a bathroom, the whole electrical interface 12 or the most of the electrical interface 12 is easily covered by water, which forms a short circuit between the first pin and the power input pin VBUS, so that the potential of the first pin is higher. Therefore, whether the conductive foreign object exists in the electrical interface 12 may be detected by detecting the potential of the first pin.

The embodiment of the present application further provides specific contents about the detection of the potential at the first pin.

Optionally, the detection module 13 may include a first voltage acquisition circuit; and the first voltage acquisition circuit may be configured to detect a potential signal at the first pin.

The first control module 11 may be specifically configured to send the feedback signal to the second control module 221 in a case that the potential reflected by the potential signal exceeds a preset potential threshold.

The first voltage acquisition circuit may be an ADC voltage sampling circuit, and the detection module may send the potential signal at the first pin acquired by the first voltage acquisition circuit to the first control module 11; and the first control module 11 may determine the potential of the first pin according to the potential signal. In the case that the potential at the first pin exceeds the preset potential threshold, it is indicated that the conductive foreign object may exist in the electrical interface 12. The first control unit may send the feedback signal to the second control module 221, which facilitates the second control module 221 to control the switch module 222 to be switched off according to the feedback signal. In the case that the potential does not exceed the preset potential threshold, it may be determined that no conductive foreign object exists between the first pin and the power input pin VBUS.

In the embodiment of the present application, if it is determined that no conductive foreign object exists between the first pin and the power input pin VBUS, whether the conductive foreign object exists between the first pin and other pins may be further detected to ensure the availability of other pins.

Optionally, the detection module 13 may be further configured to send a second electrical signal to the first control module 11; and the second electrical signal may be used for reflecting a resistance value between the first pin and the second pin.

The first control module 11 may be further configured to send the feedback signal to the second control module 221 according to the second electrical signal.

The second pin and the first pin may be arranged adjacent to each other or at an interval; for example, the second pin may be a ground pin (GND pin).

The embodiment of the present application further provides specific contents about acquisition of the second electrical signal and sending of the feedback signal according to the second electrical signal.

Optionally, the detection module 13 may further include a sensing circuit and a second voltage acquisition circuit.

The sensing circuit at least forms a return circuit with the first pin and the second pin; the return circuit may include a current source; and the current source may be controlled to be switched on by the first control module 11 when the potential is less than the preset potential threshold.

The second voltage acquisition circuit may be configured to detect a voltage value between the first pin and the second pin; the second electrical signal includes the voltage value and a current value; and the current value is a value of a current output by the current source in the return circuit.

The first control module 11 may be specifically configured to:

determine a resistance value between the first pin and the second pin according to the voltage value and the current value; and

send the feedback signal to the second control module 221 in a case that the resistance value is less than the preset resistance threshold.

In the embodiment of the present application, the sensing circuit is connected with the first pin and the second pin to form the return circuit. In order to supply a voltage to the return circuit, the current source may also be arranged in the return circuit. In the embodiment of the present application, the current value output by the current source may be customized according to actual demands within a safe range of the circuit. Specifically, the current value may be set to be 1 uA, 10 uA, 100 uA, 1 mA, and the like.

The second voltage acquisition circuit may be an ADC voltage sampling circuit; the second voltage acquisition circuit and the first voltage acquisition circuit may be the same; and the second voltage acquisition circuit may also be an additionally provided voltage sampling circuit. The second voltage acquisition circuit may detect that voltage value between the first pin and the second pin.

In practical application, in the case that the potential of the first pin does not exceed the preset potential threshold, the first control module 11 may control the current source in the return circuit to be switched on, so as to power up the return circuit.

When the conductive foreign object exists between the first pin and the second pin, the first pin and the second pin may be short-circuited, so that the resistance between the first pin and the second pin becomes smaller. Therefore, whether the conductive foreign object exists between the first pin and the second pin may be determined based on the resistance between the first pin and the second pin.

Specifically, the second electrical signal may include the voltage value between the first pin and the second pin detected by the second voltage acquisition circuit, and the current value output by the current source; and the first control module 11 may calculate the resistance between the first pin and the second pin according to the voltage value and the current value above. In another embodiment, the second electrical signal may include the resistance value calculated by the sensing circuit according to the current value and the voltage value, that is, the sensing circuit may directly calculate the resistance value, which avoids calculating again after the first control module 11 acquires the current value and the voltage value fed back by the sensing circuit.

In the case that it is determined by the first control module 11 that the resistance value is less than the preset resistance threshold, it may be indicated that the conductive foreign object exists between the first pin and the second pin, so that the resistance between the first pin and the second pin is reduced. Therefore, the first control module 11 may send the feedback signal to the second control module 221 to facilitate the second control module 221 to switch off the power supply circuit for charging the care apparatus body 1.

In the case that the resistance value is greater than or equal to the preset resistance threshold, it may be indicated that the resistance between the first pin and the second pin is normal, so that it may be determined that no conductive foreign object exists between the first pin and the second pin. Therefore, there is no need to send the feedback signal to the second control module 221.

In addition, when the current output by the current source is a fixed current, the second electrical signal may only include the voltage value between the first pin and the second pin detected by the second voltage acquisition circuit; and because the current value is unchanged, in the case that the voltage value between the first pin and the second pin is less than a preset value, it may also be indicated that the conductive foreign object exists between the first pin and the second pin.

In the embodiment of the present application, because the user may also charge the care apparatus body 1 by other charging assemblies 2, in order to avoid the electrical interface 12 or the care apparatus body 1 from being damaged by the conductive foreign object in the electrical interface 12 during charging, the care apparatus body 1 may be further provided with the protection circuit to further protect the charging safety of the care apparatus body 1.

On this basis, optionally, the care apparatus body 1 may further include a second protection circuit 14; the second protection circuit 14 may be provided with an electronic switch, an input end of the electronic switch may be connected with a power input cable in the power supply circuit, and an output end of the electronic switch may be connected with a ground wire in the power supply circuit; and a control end of the electronic switch may be connected with an output pin of the first control module 11.

The first control module 11 may be configured to send a protection instruction to the second protection circuit 14 in a case that it is determined that the conductive foreign object exists in the electrical interface 12; and the protection instruction is used for controlling the electronic switch in the second protection circuit 14 to be switched on.

In the embodiment of the present application, the electronic switch in the second protection circuit 14 may be an electronic switch with small internal resistance when switched on. For example, the electronic switch may be a MOS transistor, and the MOS transistor has milliohm internal resistance when switched on.

In practical application, the care apparatus body 1 is charged by the charging assembly 2 without power-off protection, and in the case that the conductive foreign object exists in the electrical interface 12, there may be a short circuit of the power supply circuit in the electrical interface 12. In the embodiment of the present application, the input end of the electronic switch in the second protection circuit 14 is connected with a power input cable VIN in the power supply circuit, and the output end of the electronic switch is connected with a ground wire GND in the power supply circuit, so that the short-circuited circuit in the electrical interface 12 is connected in parallel with the second protection circuit 14; and due to the milliohm internal resistance of the electronic switch in the second protection circuit 14 when the electronic switch is switched on, which is far less than impedance of the short-circuited circuit in the electrical interface 12, most of the current output by the power supply circuit may be shunted by the second protection circuit 14, so that the short-circuited circuit in the electrical interface 12 is avoided from heating continuously, thereby avoiding hot melting of the electrical interface 12.

In the case that the conductive foreign object exists in the electrical interface 12, in order to facilitate prompting the user to make the user know it and take certain measures, prompt information may be sent to the user.

Optionally, the care apparatus body 1 may further include an information prompt assembly connected with the first control module 11.

The first control module 11 is further configured to send a prompt signal to the information prompt assembly in the case that the conductive foreign object exists in the electrical interface 12; and the information prompt assembly is used for sending prompt information, and the prompt information is used for prompting the user that the conductive foreign object exists in the electrical interface 12.

The information prompt assembly may be a visual prompt assembly, such as a display screen or an indicator lamp. If the prompt assembly is the display screen, the prompt signal may be a signal for controlling the display screen to display text prompt information. If the prompt assembly is the indicator lamp, the prompt signal may be a signal for controlling the indicator lamp to light up in a preset color or flash at a preset frequency.

The information prompt assembly may also be a voice prompt assembly. If the prompt assembly is the voice prompt assembly, the prompt signal may be a signal for controlling the voice prompt assembly to output voice prompt information.

The information prompt assembly may also be a motor. If the prompt assembly is the motor, the prompt signal may be a signal for controlling the motor to vibrate.

As an optional embodiment, the embodiment of the present application further provides a charging assembly for solving the problem of charging safety of existing care apparatus.

The charging assembly 2 may include a switch module 222 and a second control module 221.

The switch module 222 is connected in series with a power supply circuit of the charging assembly 2.

The second control module 221 is configured to control the switch module 222 to be off in a case of receiving a feedback signal from the first control module 11; the first control module 11 is a module in communication connection with the second control module 221; the first control module 11 is configured to send the feedback signal to the second control module 221 in a case that a conductive foreign object exists in an electrical interface 12 of an apparatus charged by the charging assembly 2; and the electrical interface 12 is configured as an electrical connector of the apparatus.

In the embodiment of the present application, the charging assembly 2 may charge the apparatus through the electrical interface 12. The apparatus may be an apparatus with the electrical interface 12; for example, the apparatus may be electronic products such as an electric razor, an electric hair clipper, an electric face cleaner, an electric tooth cleaner, a mobile phone and a headset.

The electrical interface 12 may be a Type-C interface, a lighting interface and a trapezoidal Micro USB interface.

The first control module 11 and the second control module 221 may be control modules including at least one of a circuit board and an MCU; and types and models of the first control module 11 and the second control module 221 may be the same or different. The first control module 11 and the second control module 221 may communicate in a wired mode or a wireless mode.

The first control module 11 may be a control module arranged in the apparatus; and when the first control module in the apparatus determines that the conductive foreign object exists in the electrical interface 12, the first control module 11 may send the feedback signal to the second control module 221.

In practical application, an electrical signal in the electrical interface 12 may be acquired by a detection module 13 in the apparatus, and the first control module 11 may determine whether the conductive foreign object exists in the electrical interface 12 according to the electrical signal acquired by the detection module 13. Related contents about the detection module 13 and a principle about the determination of whether the conductive foreign object exists in the electrical interface 12 by the first control module 11 have been described in detail above, which will not be repeated herein.

In the embodiment of the present application, the switch module 222 and the second control module 221 are arranged in the charging assembly 2, and the switch module 222 is connected in series in the power supply circuit of the charging assembly 2, so that whether the power supply circuit is switched on or not may be controlled by the switch module 222. When the second control module 221 receives the feedback signal reflecting that the conductive foreign object exists in the electrical interface 12, the switch module 222 may be controlled to be off, so that the power supply circuit becomes an open circuit, that is, a power supply for charging a care apparatus body is switched off. The power supply for charging the care apparatus body 1 is switched off from the charging assembly 2 to form power-off protection, which avoids a short circuit of the power supply circuit in the electrical interface 12, thereby improving a charging safety of the apparatus.

In practical application, because wireless communication is easily interfered by electromagnetic waves and other external factors, signal transmission speed and stability may be affected, leading to poor communication reliability; and in order to ensure the safety, wired communication may be preferably used in the embodiment of the present application.

Optionally, the charging assembly 2 includes a transmission cable 22 with an electrical joint.

At least one pin of the electrical interface 12 is configured as a first communication pin; and the first control module 11 is connected with the first communication pin.

At least one pin of the electrical joint is configured as a second communication pin; and the second control module 221 is connected with the second communication pin.

The electrical interface 12 is coupled with the electrical joint, the first communication pin is connected with the second communication pin to form an electrical loop, and the second control module 221 is in communication connection with the first control module 11.

As shown in FIG. 2, a plurality of pins may be arranged in the electrical interface 12.

As shown in FIG. 3, a plurality of pins may also be arranged in the electrical joint. When the electrical interface 12 is coupled with the electrical joint, the plurality of pins in the electrical interface 12 may be correspondingly connected with the plurality of pins in the electrical joint, so as to transmit energy or signals.

In the embodiment of the present application, when the electrical interface 12 is coupled with the electrical joint, the first communication pin may be connected with the second communication pin to form a complete communication link, so that the first control module 11 may communicate with the second control module 221. The first communication pin may be connected with a data sending pin or a signal output pin of the first control module 11, which may be specifically selected according to an actual situation, and will not be specifically limited herein. The second communication pin may be connected with a data receiving pin or a signal input pin of the second control module 221, which may be specifically selected according to an actual situation, and will not be specifically limited herein.

In practical application, a TX pin in the electrical interface 12 may be used as the first communication pin, and correspondingly, a TX pin in a corresponding position of the electrical joint may be used as the second communication pin; and certainly, an RX pin in the electrical interface 12 may also be used as the first communication pin, and correspondingly, an RX pin in a corresponding position of the electrical joint may be used as the second communication pin.

As one embodiment, two TX pins skew-symmetrically arranged in the electrical interface 12 may be used as the first communication pins, and correspondingly, two TX pins skew-symmetrically arranged in corresponding positions of the electrical joint may be used as the second communication pins. Certainly, two RX pins skew-symmetrically arranged in the electrical interface 12 may also be used as the first communication pins, and correspondingly, two RX pins skew-symmetrically arranged in corresponding positions of the electrical joint may be used as the second communication pins. Therefore, the electrical interface 12 and the electrical joint may communicate regardless of forward insertion and reverse insertion.

In the embodiment of the present application, the wired communication between the first control module 11 and the second control module 221 is directly achieved by using the electrical joint and the electrical interface 12, and there is no need to select the control module with the communication function or additionally configure the wireless communication unit, thereby saving resources and costs; and meanwhile, a success rate of the second control module 221 receiving the feedback signal sent by the first control module 11 is improved, thereby improving the charging safety of the care apparatus.

Optionally, the charging assembly 2 may be the transmission cable 22; and the second control module 221 and the switch module 222 are configured in the transmission cable 22.

Optionally, the transmission cable 22 may include a wire and an electrical joint.

The second control module 221 and the switch module 222 are configured in the wire; or,

the second control module 221 and the switch module 222 are configured in the electrical joint; or,

one of the second control module 221 and the switch module 222 is configured in the electrical joint, and the other of the second control module and the switch module is configured in the wire.

The transmission cable 22 may be a data cable with charging and data or signal transmission functions.

In order to reduce carbon emissions and electronic wastes at the same time, a merchant sometimes only provides the transmission cable 22 when selling the apparatus. Therefore, the second control module 221 and the switch module 222 may be configured in the transmission cable 22 to achieve a power-off protection effect.

In the embodiment of the present application, the second control module 221 and the switch module 222 may be arranged in the wire of the transmission cable 22. Because the wire usually has a flexible structure, in order to avoid the second control module 221 and the switch module 222 from being damaged when the wire is bent, the wire may also be provided with a protective shell for protecting the second control module 221 and the switch module 222. The second control module 221 and the switch module 222 are arranged in the wire, which can avoid other electrical elements in the transmission cable 22 from affecting the second control module 221. Meanwhile, because the wire is provided with the protective shell, it is convenient for a user to distinguish the transmission cable 22 with a power-off protection function from other data cables.

In addition, the second control module 221 and the switch module 222 may also be arranged in the electrical joint. The second control module 221 and the switch module 222 are arranged in the electrical joint, so that a distance between the second control module 221 and the second communication pin is small, thereby effectively simplifying an internal wiring structure. Moreover, because the electrical joint further includes other circuit structures, the second control module 221 and the switch module 222 are arranged in the electrical joint, which avoids setting mounting positions and structures for the second control module 221 and the switch module 222 separately, thereby simplifying a structure of the transmission cable 22.

In practical application, according to actual demands, one of the second control module 221 and the switch module 222 may also be arranged in the electrical joint, and the other of the second control module and the switch module is arranged in the wire. For example, the second control module 221 may be arranged in the electrical joint, and the switch module 222 is arranged in the wire. Alternatively, the second control module 221 may also be arranged in the wire, and the switch module 222 is arranged in the electrical joint.

Optionally, the charging assembly 2 is an adapter 21.

The second control module 221 and the switch module 222 are configured in the adapter 21.

In order to reduce carbon emissions and electronic wastes at the same time, a merchant sometimes may only provide the adapter 21 when selling the apparatus. Therefore, the second control module 221 and the switch module 222 may be configured in the adapter to achieve a power-off protection effect.

Moreover, because a circuit board in the adapter 21 is relatively large, the arrangement of the second control module 221 and the switch module 222 in the adapter 21 can facilitate layout of the second control module 221 and the switch module 222. It can be understood that, in order to ensure the wired communication between the second control module 221 in the adapter 21 and the first control module 11, it is necessary to adopt a data transmission cable provided with a communication cable and the first communication pin.

Optionally, the charging assembly 2 is the transmission cable 22 and the adapter 21.

The second control module 221 and the switch module 222 are configured in the transmission cable 22; or,

the second control module 221 and the switch module 222 are configured in the adapter 21; or,

one of the second control module 221 and the switch module 222 is configured in the adapter 21, and the other of the second control module and the switch module is configured in the transmission cable 22.

When the energy storage element in the care apparatus body 1 is charged by the charging assembly 2, if a charging voltage is not matched with a standard charging voltage specified for the energy storage element; or a charging current is not matched with a standard charging current specified for the energy storage element, the service life of the energy storage element may be affected. In order to solve this problem, the charging assembly 2 may also include the transmission cable 22 and the adapter 21 at the same time.

In practical application, if the charging assembly 2 includes the transmission cable 22 and the adapter 21, positions of the second control module 221 and the switch module 222 may be set according to actual demands.

Optionally, the second control module 221 may include a control unit and a first protection circuit.

The control unit may be an MCU; and the control unit may be connected with the switch module and connected with the first control module. The control unit may control the switch module 222 to be on and off according to the feedback signal sent by the first control module. The first protection circuit may be used for protecting the control unit from being damaged under conditions of overvoltage, overcurrent, surge and electromagnetic interference. A specific structure of the first protection circuit is not specifically limited herein.

The protection of the control unit by the first protection circuit can effectively ensure that the control unit can work normally, which avoids the control unit from being damaged. For example, it can be ensured that the control unit can receive the feedback signal sent by the first control module 11 and output a corresponding control signal, thereby further ensuring the charging safety of the care apparatus.

In order to facilitate controlling the switch module 222 to be on and off, in the embodiment of the present application, the switch module 222 with a control end may be preferably selected.

Optionally, the switch module 222 may be provided with an input end, an output end and a control end; the input end is connected with one end of a power input cable in the power supply circuit; the output end is connected with the other end of the power input cable; and the control end is connected with an output pin of the second control module 221.

In the embodiment of the present application, the switch module 222 may be an electronic switch with an input end, an output end and a control end. The input end and the output end of the switch module 222 may be connected in series in the power input cable of the power supply circuit to control the power input cable to be switched on and off. Whether the input end and the output end of the switch module 222 are switched on or not may be controlled by the control end, thereby controlling the power input cable to be switched on and off. It can be understood that, when the input end and the output end of the switch module 222 are switched on, the power input cable is switched on, and the power supply circuit is a closed circuit, so that the care apparatus body 1 may be charged; and when the input end and the output end of the switch module 222 are switched off, the power input cable is switched off, and the power supply circuit is an open circuit, which is equivalent to switching off the power supply for charging the care apparatus body 1, so that the charging of the care apparatus body 1 may be stopped.

In practical application, the control end of the switch module 222 may be connected with one output pin of the second control module 221; and after the second control module 221 receives the feedback signal indicating that the conductive foreign object exists in the electrical interface 12 sent by the first control module 11, the second control module 221 may control the output pin connected with the control end to output a low-level signal or a high-level signal, thereby controlling the input end and the output end to be switched off.

In the embodiment of the present application, after the second control module 221 controls the input end and the output end of the switch module 222 to be switched off by the control end, a control signal may also be output after a first time period to control the input end and the output end to be switched on, so as to facilitate availability of the charging assembly 2 used next time. In the case that the first control module 11 determines that the conductive foreign object exists in the electrical interface 12 when the charging assembly is used next time, the second control module 221 may control the input end and the output end of the switch module 222 to be switched off again according to the feedback signal sent by the first control module 11. If a number of receiving times of the feedback signal by the second control module 221 within a preset time period is greater than a preset value, it may be indicated that the user fails to clean the conductive foreign object in the electrical interface 12, and fails to disconnect the electrical interface 12 and the electrical joint; and the signal is output to control the input end and the output end of the switch module 222 to be switched on after a second time period; and the second time period is greater than the first time period.

In the embodiment of the present application, after the second control module 221 receives the feedback signal indicating that the conductive foreign object exists in the electrical interface 12 sent by the first control module 11, the power supply circuit for charging the care apparatus body 1 is switched off by the switch module 222, which avoids a short circuit of the power supply circuit in the electrical interface 12, thereby fundamentally ensuring the charging safety of the care apparatus body 1.

Optionally, the switch module 222 may be a MOS transistor; a source of the MOS transistor may be connected with one end of the power input cable; a drain of the MOS transistor may be connected with the other end of the power input cable; and a gate of the MOS transistor may be connected with the output pin of the second control module 221.

In the embodiment of the present application, the source S of the MOS transistor may be used as the input end, the drain D of the MOS transistor may be used as the output end, and the gate G of the MOS transistor may be used as the control end. The source S and the drain D of the MOS transistor may be connected in series in the power input cable. Whether the MOS transistor is switched on or not may be controlled by controlling the gate G of the MOS transistor.

It can be understood that, when the MOS transistor is a NMOS transistor, the output pin connected with the control end of the MOS transistor in the second control module 221 may control the MOS transistor to be switched off by outputting the low-level signal; and when the MOS transistor is a PMOS transistor, the output pin connected with the control end of the MOS transistor in the second control module 221 may control the MOS transistor to be switched off by outputting the high-level signal.

In practical application, the switch module 222 may also be other electronic switches capable of being automatically controlled, such as a bipolar junction transistor, a field effect transistor and a micro relay.

FIG. 4 is a schematic diagram of an overall structure of a detection protection system provided by the embodiment of the present application. The detection protection system may be applied to the care apparatus. As shown in FIG. 4, the detection protection system includes the following parts:

1. switch module; 2. electrical interface; 3. detection module; 4. first control module; 5. second control module; 6. information prompt assembly; and 7. second protection circuit.

A detection protection principle is as follows:

the switch module is connected in series in the power input cable VIN in the power supply circuit, and the power input cable VIN may supply electric energy for the care apparatus body through the electrical interface; the detection module may acquire the electrical signal of the electrical interface and send the electrical signal to the first control module in the wired communication or wireless communication mode; the first control module may determine whether the conductive foreign object exists in the electrical interface according to the electrical signal; in the case that the conductive foreign object exists in the electrical interface, there may be a short circuit of the power input cable VIN in the electrical interface, so that the feedback signal may be sent to the second control module, so as to make the second control module control the switch module to be off after receiving the feedback signal, thereby making the power input cable VIN form an open circuit; the first control module may also send the protection instruction to the second protection circuit while sending the feedback signal to the second control module, so that the second protection circuit is switched on, thereby further protecting the short-circuited circuit in the electrical interface by using the second protection circuit; and meanwhile, the first control module may also send the prompt signal to the information prompt assembly, so that the prompt assembly sends the prompt information to prompt the user.

FIG. 5 is a schematic diagram of an electrical structure of the detection protection system provided by the embodiment of the present application. The second control module and the switch module are arranged in the transmission cable.

As shown in FIG. 5, the second control module includes the first protection circuit and the control unit. The first protection circuit may be used for protecting the control unit from being damaged under conditions of overvoltage, overcurrent, surge and electromagnetic interference. The control unit is connected with the gate of the first MOS transistor, and the source and the drain of the first MOS transistor are connected in series in the power input cable VIN; and the control unit may control whether the first MOS transistor is switched on or not through the gate of the first MOS transistor, thereby controlling whether the power input cable VIN is switched on or not.

The sensing circuit in the detection module is connected with a detection pin (PIN in FIG. 5) and a GND pin in the electrical interface. The sensing circuit further includes the current source to facilitate supplying a voltage for the sensing circuit, so as to detect the electrical signal in the electrical interface, thereby facilitating the determination of whether there is water in the electrical interface according to the electrical signal.

The detection module is in communication connection with the first control module to send the electrical signal detected for the electrical interface to the first control module. The first control module is connected with the second control module, the second protection circuit and the information prompt assembly, and sends signals or instructions to the second control module, the second protection circuit and the information prompt assembly connected according to the electrical signal sent by the detection module.

The source of the second MOS transistor in the second protection circuit is connected with the power input cable VIN in the power supply circuit, and the drain of the second MOS transistor is connected with the ground wire GND in the power supply circuit.

Under normal circumstances, in a case of inputting by the adapter, a voltage of the VIN pin in the electrical interface is 5 V, and a voltage of the detection pin PIN is low. If the electrical joint is inserted into the electrical interface under a wet condition, the short circuit of the power supply circuit may occur in the electrical interface due to water in the electrical interface.

In a case that a liquid exists in a position 1 (VIN and PIN), the detection pin PIN and the VIN pin may be short-circuited, resulting in an increase of voltage on the detection pin PIN. The voltage sampling circuit in the detection module may be connected with the detection pin PIN and acquire a first voltage signal of the detection pin PIN. The detection module may send the first voltage signal to the first control module, and in the case that the first control module determines that a voltage value on the detection pin PIN reaches a preset voltage threshold according to the first voltage signal, it may be determined that there is water in the position 1, thereby determining that the electrical interface is wet.

In a case that no liquid exists in the position 1, the first control module may control the current source in the sensing circuit in the detection module to be switched on; the current source outputs a detection current, and because the sensing circuit forms a return circuit with the detection pin PIN and the GND pin, the detection current may pass through a conducting loop formed by the liquid between the detection pin PIN and the GND pin; and due to water in a position 2, impedance between the detection pin PIN and the GND pin in the figure is lowered; the voltage sampling circuit may acquire a voltage value between the detection pin PIN and the GND pin; and the detection module may send the voltage value and the current value of the current source to the first control module. In a case that the first control module determines that resistance between the detection pin PIN and the GND pin is less than a preset resistance threshold according to the voltage value and the current value, it may be determined that the liquid exists in the position 2, thereby determining that the electrical interface is wet.

In a case that it is determined that the electrical interface is wet, on one hand, the first control module may send the feedback signal to the second control module; and in order to ensure a transmission stability and a transmission speed of the feedback signal, the feedback signal may be sent to the control unit in the second control module in a wired communication mode. After receiving the feedback signal, the control unit may output the high-level signal or the low-level signal to control the source and the drain of the first MOS transistor to be switched off, so as to control the power input cable VIN in the power supply circuit to be switched off, thereby fundamentally switching off the power supply for charging the apparatus. On the other hand, the first control module may also send the protection instruction to the second protection circuit, so that the second MOS transistor in the second protection circuit is switched on, and the second protection circuit is connected in parallel with the short-circuited circuit in the electrical interface. Due to the milliohm internal resistance of the second MOS transistor when the second MOS transistor is switched on, which is far less than impedance of the short-circuited circuit in the electrical interface, the short-circuited circuit in the electrical interface may be protected. Meanwhile, the first control module may also send the prompt signal to the information prompt assembly to facilitate the information prompt assembly to send the prompt information, so as to prompt the user that the electrical interface is wet.

At least one embodiment in the present application can achieve the following beneficial effects: by connecting the switch module in series in the power supply circuit of the charging assembly, the power supply circuit for energizing or charging a care apparatus body is controlled to be switched on and off through the switch module. In the case that the first control module of the care apparatus body determines that the conductive foreign object exists in the electrical interface, the feedback signal is sent to the second control module. The second control module controls the switch module to be off after receiving the feedback signal, so that the power supply circuit is an open circuit, thereby switching off the power supply circuit for charging the care apparatus body. A power supply of the care apparatus body is switched off from the charging assembly to form power-off protection, which avoids a short circuit of the power supply circuit in the electrical interface, thereby improving a charging safety of the apparatus.

The embodiments in the present application are all described in a progressive way, only the same and similar parts between the embodiments may be referred to each other, and each embodiment focuses on the differences from other embodiments.

The above are only the embodiments of the present application, and are not intended to limit the present application. For those skilled in the art, the present application may have various modifications and changes. Any modification, equivalent substitution, improvement, and the like made without departing from the spirit and principle of the present application should fall within the scope of the claims of the present application.

What is claimed is:

1. A care apparatus, wherein the care apparatus comprises a care apparatus body and a charging assembly;
the care apparatus body comprises an electrical interface and a first control module; and the electrical interface is configured as an electrical connector for charging the care apparatus body;
the charging assembly comprises a second control module and a switch module; and the switch module is connected in series with a power supply circuit in the charging assembly;
the second control module is in communication connection with the first control module; and
the first control module is configured to send a feedback signal to the second control module in a case that a conductive foreign object exists in the electrical interface; and the second control module is configured to control the switch module to be off after receiving the feedback signal.

2. The care apparatus according to claim 1, wherein at least one pin of the electrical interface is configured as a first communication pin; and the first control module is connected with the first communication pin;
the charging assembly further comprises a transmission cable with an electrical joint; at least one pin of the electrical joint is configured as a second communication pin; and the second control module is connected with the second communication pin; and
the electrical interface is coupled with the electrical joint, the first communication pin is connected with the second communication pin to form an electrical loop, and the second control module is in communication connection with the first control module.

3. The care apparatus according to claim 2, wherein the electrical interface is configured to have two first communication pins, and the two first communication pins are respectively located on two opposite sides of the electrical interface, and/or,
the electrical joint is configured to have two second communication pins, and the two second communication pins are respectively located on two opposite sides of the electrical joint.

4. The care apparatus according to claim 1, wherein the charging assembly is a transmission cable; and the second control module and the switch module are configured in the transmission cable.

5. The care apparatus according to claim 4, wherein the transmission cable comprises a wire and an electrical joint;
the second control module and the switch module are configured in the wire; or,
the second control module and the switch module are configured in the electrical joint; or,
one of the second control module and the switch module is configured in the electrical joint, and the other of the second control module and the switch module is configured in the wire.

6. The care apparatus according to claim 1, wherein the charging assembly is an adapter; and
the second control module and the switch module are configured in the adapter.

7. The care apparatus according to claim 1, wherein the charging assembly is a transmission cable and an adapter;
the second control module and the switch module are configured in the transmission cable; or,
the second control module and the switch module are configured in the adapter; or,
one of the second control module and the switch module is configured in the adapter, and the other of the second control module and the switch module is configured in the transmission cable.

8. The care apparatus according to claim 1, wherein the switch module is provided with an input end, an output end and a control end; the input end is connected with one end of a power input cable in the power supply circuit; the output end is connected with the other end of the power input cable; and the control end is connected with an output pin of the second control module.

9. The care apparatus according to claim 1, wherein the care apparatus further comprises a care assembly, the care assembly comprises brush filaments, a nozzle, a brush filament carrier and a brush handle, and the brush handle is configured to have a liquid flow channel;
wherein the care apparatus further comprises a drive assembly, and the drive assembly comprises a pump assembly and/or a motor assembly coupled with the care assembly.

10. The care apparatus according to claim 1, wherein the care apparatus body further comprises a detection module, and the detection module is in communication connection with the first control module; the detection module is configured to send a first electrical signal to the first control module; and the first electrical signal is used for reflecting a potential at a first pin in the electrical interface; and
the first control module is further configured to send the feedback signal to the second control module according to the first electrical signal.

11. The care apparatus according to claim 10, wherein the detection module comprises a first voltage acquisition circuit; and the first voltage acquisition circuit is configured to detect a potential signal at the first pin; and
the first control module is specifically configured to send the feedback signal to the second control module in a case that the potential reflected by the potential signal exceeds a preset potential threshold.

12. The care apparatus according to claim 10, wherein the detection module is further configured to send a second electrical signal to the first control module; and the second electrical signal is used for reflecting a resistance value between the first pin and the second pin; and
the first control module is further configured to send the feedback signal to the second control module according to the second electrical signal.

13. The care apparatus according to claim 11, wherein the detection module further comprises a sensing circuit and a second voltage acquisition circuit;
the sensing circuit at least forms a return circuit with the first pin and the second pin; the return circuit comprises a current source; and the current source is controlled to be switched on by the first control module when the potential is less than the preset potential threshold;
the second voltage acquisition circuit is configured to detect a voltage value between the first pin and the second pin; the second electrical signal comprises the voltage value and a current value; and the current value is a value of a current output by the current source in the return circuit; and
the first control module is specifically configured to:
determine a resistance value between the first pin and the second pin according to the voltage value and the current value; and
send the feedback signalto the second control module in a case that the resistance value is less than the preset resistance threshold.

14. The care apparatus according to claim 1, wherein the care apparatus body further comprises a second protection circuit; the second protection circuit is provided with an electronic switch, an input end of the electronic switch is connected with a power input cable in the power supply circuit, and an output end of the electronic switch is connected with a ground wire in the power supply circuit; and a control end of the electronic switch is connected with an output pin of the first control module; and
the first control module is configured to send a protection instruction to the second protection circuit in a case that it is determined that the conductive foreign object exists in the electrical interface; and the protection instruction is used for controlling the electronic switch in the second protection circuit to be switched on.

15. The care apparatus according to claim 1, wherein the care apparatus body further comprises an information prompt assembly connected with the first control module; and
the first control module is further configured to send a prompt signal to the information prompt assembly in the case that the conductive foreign object exists in the electrical interface; and the information prompt assembly is used for sending prompt information, and the prompt information is used for prompting a user that the conductive foreign object exists in the electrical interface.

16. A charging assembly, wherein the charging assembly comprises a switch module and a second control module;
the switch module is connected in series with a power supply circuit of the charging assembly; and
the second control module is configured to control the switch module to be off in a case of receiving a feedback signal from the first control module; the first control module is a module in communication connection with the second control module; the first control module is configured to send the feedback signal to the second control module in a case that a conductive foreign object exists in an electrical interface of an apparatus charged by the charging assembly; and the electrical interface is configured as an electrical connector of the apparatus.

17. The charging assembly according to claim 16, wherein the charging assembly comprises a transmission cable with an electrical joint;
at least one pin of the electrical interface is configured as a first communication pin; and the first control module is connected with the first communication pin;
at least one pin of the electrical joint is configured as a second communication pin; and the second control module is connected with the second communication pin; and
the electrical interface is coupled with the electrical joint, the first communication pin is connected with the second communication pin to form an electrical loop, and the second control module is in communication connection with the first control module.

18. The charging assembly according to claim 16, wherein the charging assembly is a transmission cable; and the second control module and the switch module are configured in the transmission cable;
wherein the transmission cable comprises a wire and an electrical joint;
the second control module and the switch module are configured in the wire; or,
the second control module and the switch module are configured in the electrical joint; or,
one of the second control module and the switch module is configured in the electrical joint, and the other of the second control module and the switch module is configured in the wire.

19. The charging assembly according to claim 16, wherein the charging assembly is an adapter; and
the second control module and the switch module are configured in the adapter.

20. The charging assembly according to claim 16, wherein the charging assembly is a transmission cable and an adapter;
the second control module and the switch module are configured in the transmission cable; or,
the second control module and the switch module are configured in the adapter; or,
one of the second control module and the switch module is configured in the adapter, and the other of the second control module and the switch module is configured in the transmission cable.
